(19) United States
(12) Patent Application Publication
(10) Pub. No.: US 2015/0268853 A1
(43) Pub. Date: Sep. 24, 2015

(54) Method And Apparatus For Unlocking A Touch Screen

(71) Applicant: TENCENT TECHNOLOGY (SHENZHEN) COMPANY LIMITED, Shenzhen City (CN)

(72) Inventor: Mengliang RAO, Shenzhen (CN)

(21) Appl. No.: 14/730,550

(22) Filed: Jun. 4, 2015

Related U.S. Application Data
(63) Continuation of application No. PCT/CN2013/083048, filed on Sep. 6, 2013.

(30) Foreign Application Priority Data
Dec. 13, 2012 (CN) 201210544739.X

(51) Int. Cl. G06F 3/0488; G06F 3/0484

(52) U.S. Cl. CPC G06F 3/04883; G06F 3/04842

(57) ABSTRACT

A touch screen device obtains a slide track input via a touch screen and compares the input slide track with at least one preconfigured slide track to obtain a preconfigured slide track which matches the inputted slide track. The touch screen device generates a trigger instruction according to a trigger operation corresponding to the preconfigured slide track, and executes the trigger instruction to unlock the touch screen and execute an operation corresponding to the trigger operation.

### CROSS-REFERENCE TO RELATED APPLICATIONS

This application is a continuation of International Application No. PCT/CN2013/083048, filed Sep. 6, 2013. This application claims the benefit and priority of Chinese Application No. 201210544739.X, filed Dec. 13, 2012. The entire disclosures of each of the above applications are incorporated herein by reference.

### FIELD

The present disclosure relates to touch screen fields, and a method and an apparatus for unlocking a touch screen.

### BACKGROUND

This section provides background information related to the present disclosure which is not necessarily prior art.

With the development of wireless communications, wireless Internet has become an important way for users to visit network resources. The popularization of smart terminals with touch screens makes the smart terminals with touch screens an important tool for visiting the network resources via the wireless communications.

A device with a touch screen, i.e., a touch screen device, may be in a locked state or unlocked state after being started. Under the unlocked state, a user can operate the touch screen device freely to trigger various operations. If there is no operation during a predefined time period, the touch screen device may enter into the locked state. The touch screen device in the locked state cannot be operated unless it is unlocked.

### SUMMARY

This section provides a general summary of the disclosure, and is not a comprehensive disclosure of its full scope or all of its features.

According to various embodiments, a method for unlocking a touch screen is provided. The method includes:

obtaining, by a touch screen device, a slide track input via a touch screen;

comparing, by the touch screen device, the input slide track with at least one preconfigured slide track to obtain a preconfigured slide track which matches the input slide track;

generating, by the touch screen device, a trigger instruction according to a trigger operation corresponding to the preconfigured slide track; and

executing, by the touch screen device, the trigger instruction to unlock the touch screen and executing an operation corresponding to the trigger operation.

According to various embodiments, an apparatus for unlocking a touch screen is provided. The apparatus includes:

one or more processors;

a memory; and

one or more program modules stored in the memory and to be executed by the one or more processors, the one or more program modules comprise:

an obtaining module, to obtain a slide track input via a touch screen;

a comparing module, to compare the input slide track with at least one preconfigured slide track to obtain a preconfigured slide track which matches the input slide track;

an instruction generating module, to generate a trigger instruction according to a trigger operation corresponding to the preconfigured slide track; and

an executing module, to execute the trigger instruction to unlock the touch screen and execute an operation corresponding to the trigger operation.

According various embodiments, a non-transitory computer-readable storage medium comprising a set of instructions for unlocking a touch screen is provided, the set of instructions to direct at least one processor to perform acts of:

obtaining a slide track input via a touch screen;

comparing the input slide track with at least one preconfigured slide track to obtain a preconfigured slide track which matches the input slide track;

generating a trigger instruction according to a trigger operation corresponding to the preconfigured slide track; and

executing the trigger instruction to unlock the touch screen and executing an operation corresponding to the trigger operation.

Other aspects according to various embodiments will be understood by those skilled in the art in view of the description, the claims, and the drawings of the present disclosure.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

Features of the present disclosure are illustrated by way of example and are not limited in the following figures, in which like numerals indicate like elements.

FIG. 1 is a diagram illustrating a touch screen device according to various embodiments.

FIG. 2 is a flowchart illustrating a method for unlocking a touch screen according to various embodiments.

FIG. 3 is a flowchart illustrating a process of executing a trigger instruction in FIG. 1 according to various embodiments.

FIG. 4 is a flowchart illustrating a method for unlocking a touch screen according to various embodiments.

FIG. 5 is a diagram illustrating an apparatus for unlocking a touch screen according to various embodiments.

FIG. 6 is a diagram illustrating a structure of an executing module in FIG. 4 according to various embodiments.

FIG. 7 is a diagram illustrating an apparatus for unlocking a touch screen according to various embodiments.

Corresponding reference numerals indicate corresponding parts throughout the several views of the drawings.

### DETAILED DESCRIPTION

Example embodiments will now be described more fully with reference to the accompanying drawings.

The preset disclosure will be described in further detail hereinafter with reference to accompanying drawings and examples to make the technical method and qualities therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

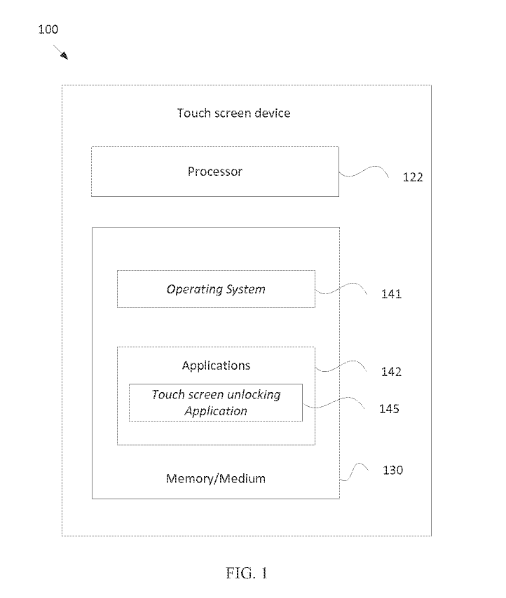

FIG. 1 is a diagram illustrating a touch screen device 100 according to various embodiments. The touch screen device 100 may be a device capable of executing a method and apparatus of the present disclosure. The touch screen device 100 may, for example, be a device such as a smart phone. The touch screen device 100 may include or may execute a variety of operating systems 141 and a variety of possible applications 142, such as a touch screen unlocking application 145.

The touch screen device 100 may also include one or more non-transitory processor-readable storage media 130 and one or more processors 122 in communication with the non-transitory processor-readable storage media 130. For example, the non-transitory processor-readable storage media 130 may be any form of non-transitory storage medium known in the art. The one or more non-transitory processor-readable storage media 130 may store sets of instructions, or units and/or modules that comprise the sets of instructions, for conducting operations described in the present disclosure. The one or more processors may be configured to execute the sets of instructions and perform the operations according to various embodiments

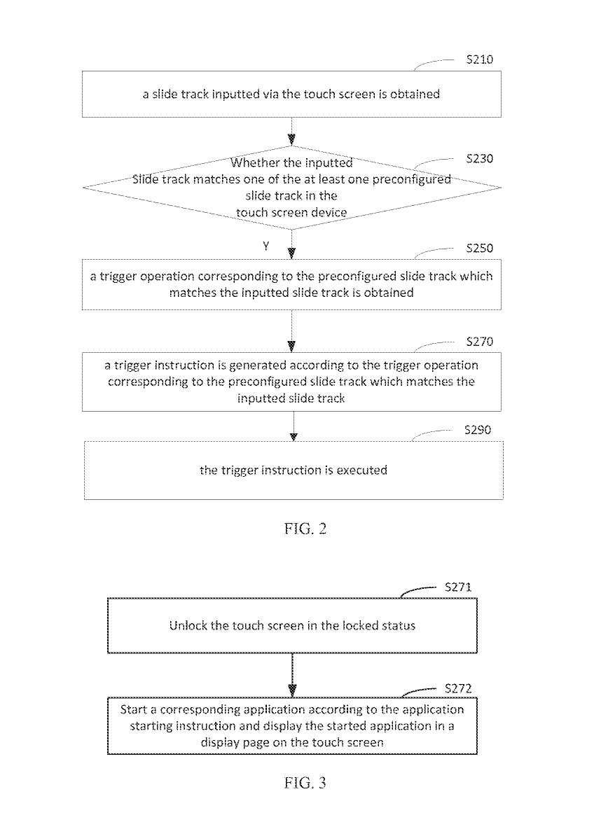

FIG. 2 is a diagram illustrating a method for unlocking a touch screen according to various embodiments. FIG. 2 is a simplified diagram according to various embodiments. This diagram is an example which should not unduly limit the scope of the claims. One with ordinary skill in the art will recognize many variations, alternatives, and modifications.

As shown in FIG. 2, the method includes the following.

Block 210: A slide track input via the touch screen is obtained. A user may move a finger on the touch screen to generate a slide gesture. At this time, along with the movement of the slide gesture of the user on the touch screen, the slide track is recorded.

Block 230: It is determined whether the input slide track matches one of the at least one preconfigured slide track in the touch screen device. If the input slide track matches one of the at least one preconfigured slide track, block S250 is performed; otherwise, the method ends. At least one slide track is preconfigured and stored in the touch screen device. The input slide track is compared with the at least one preconfigured slide track one by one. Thus, according to a degree of similarity between the input slide track and each of the at least one preconfigured slide track, a preconfigured slide track which is most similar to the input slide track may be obtained. If it is determined that the input slide track does not match any one of the preconfigured slide track, it indicates that the input slide track is invalid.

Block 250: A trigger operation corresponding to the preconfigured slide track which matches the input slide track is obtained. According to various embodiments, a mapping relationship between the preconfigured slide track and the trigger operation is stored in the touch screen device in advance. The trigger operation unlocks the touch screen or unlocks the touch screen and triggers an operation, e.g., starting an application or a system tool in the touch screen device. The trigger operation may also be used for unlocking the touch screen and closing a window after the touch screen is unlocked. Those with ordinary skill in the art may configure other kinds of trigger operations, which are not described in the present disclosure. After comparing the input slide track with the at least one preconfigured slide track and obtaining the preconfigured slide track which matches the input slide track, the trigger operation corresponding to the matching preconfigured slide track is obtained according to the mapping relationship between the preconfigured slide track and the trigger operation.

Block 270: A trigger instruction is generated according to the trigger operation corresponding to the preconfigured slide track which matches the input slide track. According to various embodiments, an intention of the user, i.e., an operation to be triggered after the user unlocks the touch screen device, may be obtained according to the trigger operation corresponding to the preconfigured slide track which matches the input slide track and a corresponding trigger instruction can then be generated. Therefore, the trigger instruction generated according to the trigger operation corresponding to the preconfigured slide track which matches the input slide track can recognize the intention of the user accurately, i.e., implement the trigger operation corresponding to the preconfigured slide track in the touch screen device.

Block 290: the trigger instruction is executed. According to various embodiments, the generated trigger instruction is executed in the touch screen device, such that the user does not need to perform an additional operation, which greatly increases operational convenience for the user.

An exemplary method for unlocking a touch screen is described with reference to the above blocks 210 through 290. The user may configure multiple different slide tracks for unlocking the touch screen, wherein each of them corresponds to a unique trigger operation, which further uniquely corresponds to a trigger instruction. The trigger instruction includes a touch screen unlocking instruction and an application starting instruction. Different slide tracks may correspond to different trigger operations and trigger instructions. For example, if the trigger instruction is an instruction for starting a music player, after the touch screen is unlocked, the music player is started directly. If the trigger instruction is an instruction for ending all applications in the touch screen device, after the touch screen is unlocked, all applications in the touch screen device are directly closed.

FIG. 3 is a flowchart illustrating a process of executing the trigger instruction according to various embodiments. FIG. 3 is a simplified diagram according to various embodiments. This diagram is an example which should not unduly limit the scope of the claims. One with ordinary skill in the art will recognize many variations, alternatives, and modifications.

As shown in FIG. 3, the trigger instruction is an application starting instruction. Block 290 includes blocks 291 and 292.

Block 291: The touch screen is unlocked.

Block 292: An application is started according to the application starting instruction and the started application is displayed in a displaying page on the touch screen.

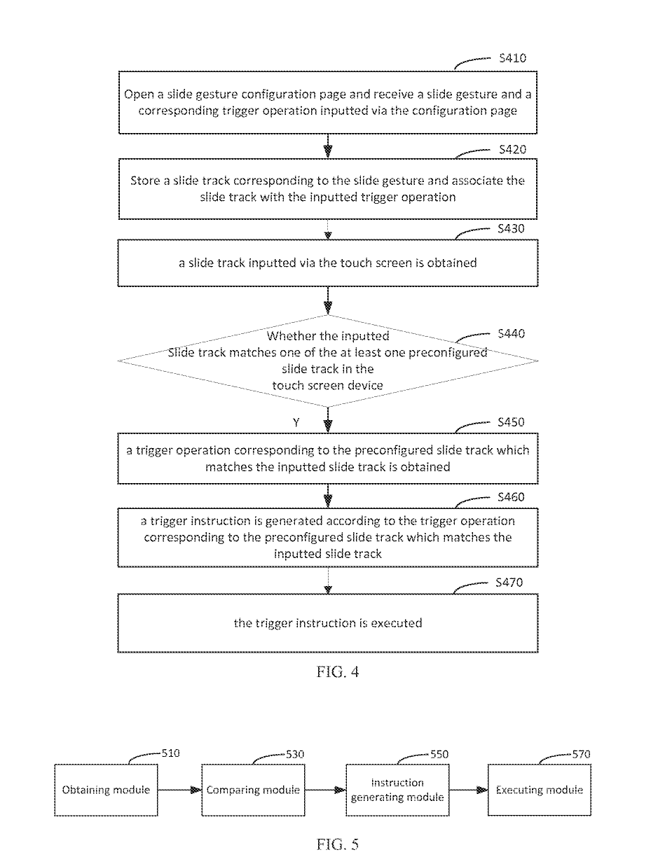

FIG. 4 is a flowchart illustrating a method for unlocking a touch screen according to various embodiments. FIG. 4 is a simplified diagram according to various embodiments. This diagram is an example which should not unduly limit the scope of the claims. One with ordinary skill in the art will recognize many variations, alternatives, and modifications.

Block 410: A slide track configuration page is opened and a slide gesture and a corresponding trigger operation are input in the slide track configuration page. According to various embodiments, the user may perform a custom setting to the slide gesture used for unlocking the touch screen. The configuration page of the slide gesture is opened and displayed on the touch screen through a custom setting operation on the touch screen. At this time, a different gesture is created. The input slide gesture and the operation to be triggered by the slide gesture (i.e., the trigger operation) are obtained. The user may configure multiple slide gestures. Different slide gestures may unlock the touch screen and correspond to different trigger operations, so as to improve operational convenience for the user.

Block 420: A slide track corresponding to the slide gesture is stored and the slide track is associated with the input trigger operation. According to various embodiments, the slide track is obtained according to the slide gesture input via the touch screen and is stored in association with the corresponding trigger operation.

Blocks 430 through 470 are respectively the same as blocks 210 through 290 and are not repeated herein.

After a slide track and the corresponding trigger operation are configured, it is also possible to delete the self-configured slide track and trigger operation according to a user requirement, so as to organize the stored slide tracks and trigger operations and facilitate the creation of different slide tracks.

FIG. 5 is a diagram illustrating an apparatus for unlocking a touch screen according to various embodiments. FIG. 5 is a simplified diagram according to various embodiments. This diagram is an example which should not unduly limit the scope of the claims. One with ordinary skill in the art will recognize many variations, alternatives, and modifications.

As shown in FIG. 5, the apparatus includes an obtaining module 510, a comparing module 530, an instruction generating module 550, and an executing module 570. The obtaining module 510 is configured to obtain a slide track input via the touch screen. The obtaining module 510 records the slide track corresponding to a slide gesture on the touch screen, wherein the slide track is generated by the slide gesture triggered by the user on the touch screen. The user inputs the slide gesture via the touch screen. At this time, the obtaining module 510 records a corresponding slide track according to the movement of the slide gesture of the user.

The comparing module 530 is configured to determine whether the input slide track matches one of the at least one preconfigured slide track in the touch screen device and to obtain a trigger operation corresponding to the matching preconfigured slide track if the input slide track matches one of the at least one preconfigured slide track. The at least one slide track is configured in advance and is stored in the touch screen device. The comparing module 530 compares the input slide track with the at least one preconfigured slide track one by one, so as to obtain a preconfigured slide track most similar to the input slide track according to a degree of similarity between the input slide track and the at least preconfigured slide track.

The touch screen device stores a mapping relationship between the preconfigured slide track and the trigger operation in advance. The trigger operation unlocks the touch screen or unlocks the touch screen and triggers an operation, e.g., starting an application or a system tool in the touch screen device. The trigger operation may also be used for unlocking the touch screen and closing a window after the touch screen is unlocked. Those with ordinary skill in the art may configure other kinds of trigger operations, which are not described in the present disclosure.

After comparing the input slide track with the preconfigured slide track and obtaining the preconfigured slide track which matches the input slide track, the comparing module 530 obtains the trigger operation corresponding to the preconfigured slide track which matches the input slide track according to the mapping relationship between the preconfigured slide track and the trigger operation. If it is determined that the input slide track does not match any one of the preconfigured slide tracks, it indicates that the input slide track is invalid.

The instruction generating module 550 is configured to generate a trigger instruction according to the trigger operation obtained by the comparing module 530. The instruction generating module 550 may obtain an intention of the user, i.e., an operation to be triggered after the user unlocks the touch screen device, according to the trigger operation corresponding to the preconfigured slide track and generate a corresponding trigger instruction. Therefore, the trigger instruction generated according to the trigger operation corresponding to the preconfigured slide track can recognize the intention of the user accurately, i.e., implement the trigger operation corresponding to the preconfigured slide track in the touch screen device.

The executing module 570 is configured to execute the trigger instruction to unlock the touch screen and execute an operation corresponding to the trigger operation. According to various embodiments, the executing module 570 executes the generated trigger instruction in the touch screen device, such that the user does not need to perform an additional operation to execute the operation, which greatly increases the operational convenience for the user.

The user may configure multiple different slide tracks for unlocking the touch screen, wherein each corresponds to a unique trigger operation which further uniquely corresponds to a trigger instruction. The trigger instruction includes a touch screen unlocking instruction and an application starting instruction. Different slide tracks may correspond to different trigger operations and trigger instructions. For example, if the trigger instruction is an instruction for starting a music player, after the touch screen is unlocked, the executing module 570 starts the music player directly. If the trigger instruction is an instruction for ending all applications in the touch screen device, after the touch screen is unlocked, the executing module 570 closes all applications in the touch screen device directly.

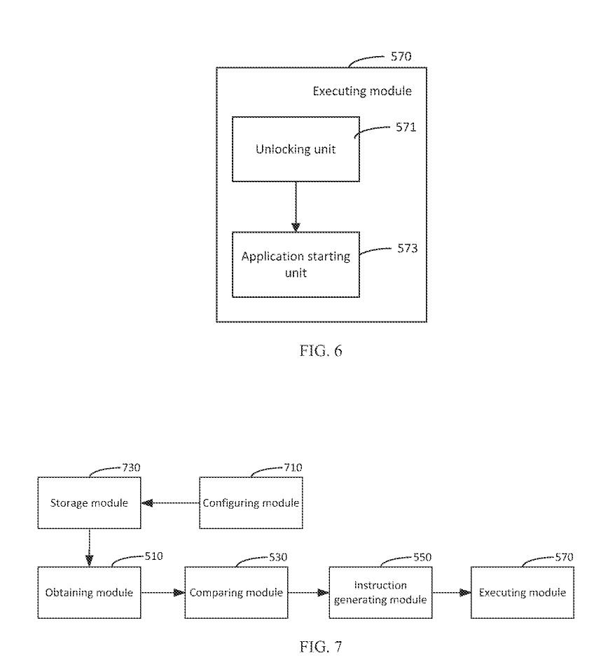

FIG. 6 is a diagram illustrating a structure of the executing module 570 according to various embodiments. FIG. 6 is a simplified diagram according to various embodiments. This diagram is an example which should not unduly limit the scope of the claims. One with ordinary skill in the art will recognize many variations, alternatives, and modifications.

As shown in FIG. 6, the trigger instruction is an application starting instruction. At this time, the executing module 570 includes an unlocking unit 571 and an application starting unit 573. The unlocking unit 571 is configured to unlock the touch screen. The application starting unit 573 is configured to start an application according to the application starting instruction and display the started application in a display page on the touch screen.

FIG. 7 is a diagram illustrating a structure of an apparatus for unlocking a touch screen according to various embodiments. FIG. 7 is a simplified diagram according to various embodiments. This diagram is an example which should not unduly limit the scope of the claims. One with ordinary skill in the art will recognize many variations, alternatives, and modifications.

As shown in FIG. 7, the apparatus includes an obtaining module 510, a comparing module 530, an instruction generating module 550, an executing module 570, a configuring module 710, and a storage module 730.

Functions and operations of the obtaining module 510, the comparing module 530, the instruction generating module 550, and the executing module 570 as shown in FIG. 7 are similar to the corresponding modules as shown in FIG. 5 and will not be repeated herein.

The configuring module 710 is configured to open a slide track configuration page and receive a slide gesture and a corresponding trigger operation input in the configuration page. The user may perform a custom setting to the slide gesture used for unlocking the touch screen. The configuring module 710 opens the configuration page of the slide gesture and displays the configuration page on the touch screen through a custom setting operation on the touch screen. At this time, a different gesture is created. The input slide gesture and the operation to be triggered by the slide gesture (i.e., the trigger operation) are obtained. The user may configure multiple slide gestures. Different slide gestures may unlock the touch screen and correspond to different trigger operations, so as to improve operational convenience for the user.

The storage module 730 is configured to store the slide track corresponding to the slide gesture and associate the slide track with the input trigger operation. According to various embodiments, the storage module 730 obtains the slide track according to the slide gesture and stores the slide track in association with the trigger operation. After a slide track and the corresponding trigger operation are configured, the storage module 730 may delete the stored slide track and the corresponding trigger operation according to a user requirement, so as to organize the stored slide tracks and trigger operations and facilitate the creation of different slide tracks.

The above modules may be program modules stored in the non-transitory processor-readable storage media 130 and executable by the one or more processors 122 as shown in FIG. 1.

According to the method and apparatus provided by the various embodiments, an input slide track is compared with at least one preconfigured slide track in the touch screen device to obtain a preconfigured slide track which matches the input slide track. According to the preconfigured slide track that matches the input slide track, a trigger operation is obtained and a trigger instruction is generated according to the trigger operation. Thus, an operation corresponding to the trigger instruction can be executed without additional operation by the user, which greatly increases operational convenience for the user.

What is described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for unlocking a touch screen, comprising:
obtaining, by a touch screen device, a slide track inputted via a touch screen;
comparing, by the touch screen device, the inputted slide track with at least one preconfigured slide track to obtain a preconfigured slide track which matches the inputted slide track;
generating, by the touch screen device, a trigger instruction according to a trigger operation corresponding to the preconfigured slide track; and
executing, by the touch screen device, the trigger instruction to unlock the touch screen and executing an operation corresponding to the trigger operation.

2. The method of claim 1, wherein the comparing the inputted slide track with the at least one preconfigured slide track to obtain the preconfigured slide track which matches the inputted slide track comprises:
comparing, by the touch screen device, the inputted slide track with the at least one preconfigured slide track, determining whether the inputted slide track matches one of the at least one preconfigured slide track, if the inputted slide track matches one of the at least one preconfigured slide track, obtaining, by the touch screen device, the trigger operation corresponding to the preconfigured slide track which matches the inputted slide track.

3. The method of claim 1, wherein the trigger instruction is an application starting instruction, the executing the trigger instruction comprises:
unlocking, by the touch screen device, the touch screen in a locked state; and
starting, by the touch screen device, an application corresponding to the application starting instruction and displaying the started application in a displaying page on the touch screen.

4. The method of claim 1, further comprising:
before obtaining the slide track inputted via the touch screen, opening, by the touch screen device, a slide track configuring page, receiving a slide gesture and the corresponding trigger operation inputted in the configuration page; and
storing, by the touch screen device, the slide track corresponding to the slide gesture in association with the inputted trigger operation.

5. An apparatus for unlocking a touch screen, comprising:
one or more processors;
a memory; and
one or more program modules stored in the memory and to be executed by the one or more processors, the one or more program modules comprise:
an obtaining module, to obtain a slide track inputted via a touch screen;
a comparing module, to compare the inputted slide track with at least one preconfigured slide track to obtain a preconfigured slide track which matches the inputted slide track;
an instruction generating module, to generate a trigger instruction according to a trigger operation corresponding to the preconfigured slide track; and
an executing module, to execute the trigger instruction to unlock the touch screen and execute an operation corresponding to the trigger operation.

6. The apparatus of claim 5, wherein the comparing module is further to
compare the inputted slide track with the at least one preconfigured slide track,
determine whether the inputted slide track matches one of the at least one preconfigured slide track, and
obtain the trigger operation corresponding to the preconfigured slide track which matches the inputted slide track if the inputted slide track matches one of the at least one preconfigured slide track.

7. The apparatus of claim 5, wherein the trigger instruction is an application starting instruction, the executing module comprises:
an unlocking unit, configured to unlock the touch screen in a locked state; and
an application starting unit, configured to start an application corresponding to the application starting instruction and display the started application in a displaying page on the touch screen.

8. The apparatus of claim 5, further comprising:
a configuring module, configured to open a slide track configuring page and receive a slide gesture and the corresponding trigger operation inputted in the configuration page; and
a storage module, configured to store the slide track corresponding to the slide gesture in association with the inputted trigger operation.

9. A non-transitory computer-readable storage medium comprising a set of instructions for unlocking a touch screen, the set of instructions to direct at least one processor to perform acts of:
obtaining a slide track inputted via a touch screen;
comparing the inputted slide track with at least one preconfigured slide track to obtain a preconfigured slide track which matches the inputted slide track;
generating a trigger instruction according to a trigger operation corresponding to the preconfigured slide track; and
executing the trigger instruction to unlock the touch screen and executing an operation corresponding to the trigger operation.

10. The non-transitory computer-readable storage medium of claim 9, wherein the comparing the inputted slide track with the at least one preconfigured slide track to obtain the preconfigured slide track which matches the inputted slide track comprises:
comparing the inputted slide track with the at least one preconfigured slide track, determining whether the inputted slide track matches one of the at least one preconfigured slide track, if the inputted slide track matches one of the at least one preconfigured slide track, obtaining the trigger operation corresponding to the preconfigured slide track which matches the inputted slide track.

11. The non-transitory computer-readable storage medium of claim 9, wherein the trigger instruction is an application starting instruction, the executing the trigger instruction comprises:
unlocking the touch screen in a locked state; and
starting an application corresponding to the application starting instruction and displaying the started application in a displaying page on the touch screen.

12. The non-transitory computer-readable storage medium of claim 9, further comprising a set of instructions to direct at least one processor to perform acts of:
before obtaining the slide track inputted via the touch screen, opening a slide track configuring page, receiving a slide gesture and the corresponding trigger operation inputted in the configuration page; and
storing the slide track corresponding to the slide gesture in association with the inputted trigger operation.
